(19) United States
(12) Patent Application Publication
(10) Pub. No.: US 2024/0022055 A1
(43) Pub. Date: Jan. 18, 2024

(54) FLOOR BOX COVER

(71) Applicant: Leviton Manufacturing Co., Inc., Melville, NY (US)

(72) Inventor: Thiru Murugan, Wakefield, MA (US)

(21) Appl. No.: 18/039,794

(22) PCT Filed: Jan. 11, 2022
(86) PCT No.: PCT/US2022/011921

§ 371 Date: Jun. 1, 2023

Related U.S. Application Data
(60) Provisional application No. 63/199,849, filed on Jan. 28, 2021.
(60) Provisional application No. 63/202,565, filed on Jun. 16, 2021.

(51) Int. Cl. H02G 3/08; H02G 3/18; H02G 3/14; H01R 13/447

(52) U.S. Cl. CPC H02G 3/081; H02G 3/185; H02G 3/14; H02G 3/088; H01R 13/447

(57) ABSTRACT

Floor box cover assemblies configured to couple to a floor box, which house one or more wiring devices are disclosed. In use, the floor box cover assemblies are configured to transition between a first or closed position and a second or opened position to enable selective access to the one or more wiring devices positioned within the floor box. Thus arranged, in the opened position, the floor box cover assembly enables an end-user to access a wiring device positioned within the floor box. In the closed position, the floor box cover assembly inhibits the ingress of liquids or debris. In one embodiment, the floor box cover assembly includes a cover plate that is rotatable between the opened and closed positions. In another embodiment, the floor box cover assembly includes a cover plate that is configured to be moved into a cover storage box when in the opened position.

### CROSS-REFERENCE TO RELATED APPLICATIONS

This is a non-provisional of, and claims the benefit of the filing date of, pending U.S. Provisional Patent Application No. 63/199,849, filed on Jan. 28, 2021, entitled “Floor Box Cover,” and is a non-provisional of, and claims the benefit of the filing date of, pending U.S. Provisional Patent Application No. 63/202,565, filed on Jun. 16, 2021, entitled “Floor Box Cover,” each of which application is incorporated by reference herein in its entirety.

### FIELD OF THE DISCLOSURE

The present disclosure relates generally to floor box cover assemblies, and more particularly to a floor box cover assembly moveable between first and second positions to provide selective access to an electrical wiring device. In one embodiment, the floor box cover assembly includes a cover plate which can be rotated between first and second positions. In an alternate embodiment, the cover plate can be stowed-away when access to the wiring device is provided. Thus arranged, in use, the floor box cover assemblies are arranged and configured so that no part of the cover assembly extends past, above, etc. an upper surface of the cover plate (e.g., the height of the cover plate assembly is substantially similar regardless of the cover plate assembly being in the first or second position).

### BACKGROUND OF THE DISCLOSURE

The use of electrical junction boxes to accommodate electrical cable terminations is well known in the art. Generally speaking, electrical junction boxes house one or more electrical components or wiring devices, such as electrical receptacles, outlets, switches, data connectors, etc. The electrical junction boxes permit the electrical cables to either pass through or connect to the wiring devices housed inside the electrical junction box. In certain applications, these electrical junction boxes are used in floor installations and thus are referred to as floor boxes. In these situations, electrical cable distribution takes place beneath the surface of the floor and the floor boxes are designed to be supported within the floor.

In various embodiments, the floor box may include a flange which sits on top of the floor surface. Alternatively, the floor box may sit partly or fully flush with the floor surface in some “flush” and “recessed” type designs. In any event, the floor box includes an opening to permit access to the wiring device positioned therein. A cover is typically movably positioned over the opening. In use, the cover is movable between a first or closed position, wherein the opening is covered, and a second or opened position, wherein the opening is uncovered, to permit access to the wiring device positioned within the floor box. Generally speaking, the cover is pivotably secured to the flange by a hinge. As such, the cover may be referred to as a flip-lid.

One problem with flip-lid cover assemblies is that, when the cover plate is in the second or opened position, the cover plate extends away from the floor creating, for example, a tripping hazard, which could result in injury to a person or damage to the wiring device, floor box, cover assembly, etc.

In addition, floor boxes may be exposed to debris, water, etc. For example, during floor cleaning, water or other debris may enter the floor box creating an unsafe condition.

Thus, it would be desirable to provide a floor box cover assembly, which when in the second or opened position maintains a low-profile (e.g., cover plate does not protrude away from the floor). In addition, it would be desirable to provide a floor box cover assembly, which when in the first or closed position, resists the ingress of debris and water. It is with respect to these and other considerations that the present improvements may be useful.

### SUMMARY OF THE DISCLOSURE

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

Disclosed herein is a floor box cover assembly arranged and configured to be coupled to a floor box, which houses a wiring device. In one embodiment, the floor box cover assembly includes a base plate including an aperture to allow access to the wiring device positioned within the floor box and a cover plate rotatably coupled to the base plate, the cover plate including an aperture, the cover plate being rotatable between a first position and a second position to enable selective access to the wiring device positioned within the floor box, wherein, in the first position, the aperture formed in the cover plate is not aligned with the aperture formed in the base plate to prohibit access to the wiring device and wherein, in the second position, the aperture formed in the cover plate is aligned with the aperture formed in the base plate to enable an end-user to access the wiring device positioned within the floor box.

In one embodiment, the floor box cover assembly further includes a lock fastener arranged and configured to couple the cover plate to the base plate, wherein, in a loosen state, the lock fastener allows the cover plate to rotate relative to the base plate between the first and second positions, and in a tightened state, the cover plate is non-rotatable relative to the base plate.

In one embodiment, the base plate further comprises a raised surface including a size and shape corresponding to the aperture formed in the cover plate, wherein in the first position, the raised surface of the base plate projects into the aperture formed in the cover plate.

In one embodiment, the floor box cover assembly further includes a seal positioned between the base plate and the cover plate, the seal arranged and configured to prevent ingress of water and debris between the base plate and the cover plate.

In one embodiment, the base plate includes a cavity arranged and configured to receive the seal and the cover plate therein so that, when assembled, a top surface of the cover plate sits flush with respect to a top surface of the base plate.

In one embodiment, the seal includes first and second apertures, each of the first and second apertures including a size and shape corresponding to a size and shape of the apertures formed in the base plate and cover plate, the first aperture formed in the seal is aligned with the aperture formed in the base plate to allow access to the wiring device, the second aperture formed in the seal is aligned with the raised surface formed on the base plate so that the raised surface protrudes through the second aperture of the seal.

In one embodiment, the base plate includes indicia arranged and configured to indicate a position of the cover plate.

In an alternate embodiment, a floor box cover assembly arranged and configured to be coupled to a floor box, which houses a wiring device is disclosed. The floor box cover assembly including a cover plate including an aperture sized and configured to enable access to the wiring device positioned within the floor box, a base plate including an aperture to allow access to the wiring device positioned within the floor box and a raised surface including a size and shape corresponding to the aperture formed in the cover plate, wherein the cover plate is rotatably coupled to the base plate, the cover plate being rotatable between a first position and a second position, wherein, in the first position, the aperture formed in the cover plate is not aligned with the aperture formed in the base plate to prohibit access to the wiring device, the aperture formed in the cover plate is aligned with the raised surface of the base plate so that the raised surface protrudes into the aperture formed in the cover plate, and wherein, in the second position, the aperture formed in the cover plate is aligned with the aperture formed in the base plate to enable an end-user to access the wiring device positioned within the floor box.

In one embodiment, the floor box cover assembly further includes a lock fastener arranged and configured to couple the cover plate to the base plate, wherein, in a loosen state, the lock fastener allows the cover plate to rotate relative to the base plate between the first and second positions, and in a tightened state, the cover plate is non-rotatable relative to the base plate.

In one embodiment, the floor box cover assembly further includes a seal positioned between the base plate and the cover plate, the seal arranged and configured to prevent ingress of water and debris between the base plate and the cover plate.

In one embodiment, the base plate includes a cavity arranged and configured to receive the seal and the cover plate therein so that, when assembled, a top surface of the cover plate sits flush with respect to a top surface of the base plate.

In one embodiment, the seal includes first and second apertures, the first aperture formed in the seal is aligned with the aperture formed in the base plate to allow access to the wiring device, the second aperture formed in the seal is aligned with the raised surface formed on the base plate so that the raised surface protrudes through the second aperture of the seal.

In yet another alternate embodiment, a floor box cover assembly arranged and configured to be coupled to a floor box, which houses a wiring device, is disclosed. The floor box cover assembly including a base plate arranged and configured to couple to the floor box, the base plate including an aperture to enable access to the wiring device, a cover plate coupled to the base plate, the cover plate moveable between a first position and a second position to enable selective access to the wiring device, and a cover storage box arranged and configured to receive the cover plate, wherein, in the first position, the cover plate is coupled to the base plate and extends across the aperture to prohibit access to the wiring device, and wherein, in the second position, the cover plate is positioned within the cover storage box to enable an end-user to access the wiring device positioned within the floor box.

In one embodiment, the floor box cover assembly further includes a plate fastener arranged and configured to secure the cover plate to the base plate in the first position.

In one embodiment, the cover plate is detachably coupled to the base plate so that, in the second position, the cover plate is detached from the base plate and stored in the cover storage box.

In one embodiment, the base plate includes a second aperture arranged and configured to provide access to the cover storage box.

In one embodiment, the cover plate is hingeably coupled to the base plate.

In one embodiment, the cover plate and the base plate further comprise a rack and pinion to move the cover plate relative to the base plate.

In one embodiment, the floor box cover assembly further includes a spring arranged and configured to facilitate moving the cover plate relative to the base plate.

### BRIEF DESCRIPTION OF THE DRAWINGS

By way of example, a specific embodiment of the disclosed device will now be described, with reference to the accompanying drawings, in which:

FIG. 1 is a perspective view of an embodiment of a floor box cover assembly according to one or more features of the present disclosure;

FIG. 2 is a perspective, exploded view of the floor box cover assembly shown in FIG. 1;

FIG. 3 is a perspective, exploded view of the floor box cover assembly shown in FIG. 1, the floor box cover assembly being shown in relation to a floor box installed in a floor;

FIG. 4 is a top view of the floor box cover shown in FIG. 1, the floor box cover assembly being shown as installed in the floor where the rotatable cover plate is in a second or opened position;

FIG. 5 is a top view of the floor box cover assembly shown in FIG. 4, where the rotatable cover plate is transitioning between the second or opened position to a first or closed position;

FIG. 6 is a top view of the floor box cover assembly shown in FIG. 4, where the rotatable cover plate is in the first or closed position;

FIG. 7 is a cross-sectional view of the floor box cover assembly taken along line A-A in FIG. 4;

FIG. 8 is an exploded, perspective view of a floor box assembly according to one or more features of the present disclosure;

FIG. 9 is an exploded, perspective view of an alternate embodiment of a floor box cover assembly according to one or more features of the present disclosure;

FIG. 10 is a top view of the floor box cover assembly shown in FIG. 9, the floor box cover assembly being shown where the rotatable cover plate is in a second or opened position;

FIG. 11 is a top view of the floor box cover assembly shown in FIG. 9, where the rotatable cover plate is in a first or closed position;

FIG. 12 is a cross-sectional, perspective view of an alternate embodiment of a floor box cover assembly according to one or more features of the present disclosure;

FIG. 13 is a perspective view of an alternate embodiment of a floor box cover assembly in accordance with one or more features of the present disclosure;

FIG. 14 is a perspective view of an alternate embodiment of a floor box cover assembly in accordance with one or more features of the present disclosure;

FIG. 15 is a perspective view of an alternative embodiment of a floor box cover assembly according to one or more features of the present disclosure;

FIG. 16 is a perspective view of the floor box cover assembly of FIG. 15 with the cover plate removed;

FIG. 17 is a perspective, exploded view of the floor box cover assembly of FIG. 15;

FIG. 18 is another perspective, exploded view of the floor box cover assembly of FIG. 15 with some of the components removed for clarity;

FIG. 19 is a perspective view of a lock fastener hat may be used in connection with the floor box cover assembly of FIG. 15;

FIG. 20 is a perspective view of an alternative embodiment of a floor box cover assembly according to one or more features of the present disclosure;

FIG. 21 is a cross-sectional view of the floor box cover assembly of FIG. 20;

FIG. 22 is a perspective view of another alternative embodiment of a floor box cover assembly according to one or more features of the present disclosure;

FIG. 23 is a perspective view of the floor box cover assembly of FIG. 22 with some components removed for clarity; and

FIG. 24 is a cross-sectional view of the floor box cover assembly of FIG. 22.

The drawings are not necessarily to scale. The drawings are merely representations, not intended to portray specific parameters of the disclosure. The drawings are intended to depict example embodiments of the disclosure, and therefore are not to be considered as limiting in scope. In the drawings, like numbering represents like elements.

### DETAILED DESCRIPTION

Numerous embodiments of floor box cover assemblies arranged and configured to be installed on, or coupled to, electrical junction boxes or floor boxes (terms used interchangeably herein) will now be described more fully hereinafter with reference to the accompanying drawings, in which preferred embodiments of the present disclosure are presented. In accordance with one or more features of the present disclosure, the floor box cover assemblies are arranged and configured to transition between first and second positions to enable selective access to one or more wiring devices, which may be positioned within the floor box. In use, the floor box cover assemblies may, however, be embodied in many different forms and should not be construed as being limited to the embodiments set forth herein. Rather, these embodiments are provided so that this disclosure will convey certain example features to those skilled in the art.

In accordance with one or more features of the present disclosure, the floor box cover assembly is arranged and configured to couple to a floor box, which may house one or more wiring devices. In use, the floor box cover assemblies are arranged and configured to transition between a first or closed position and a second or opened position to enable selective access to the one or more wiring devices positioned within the floor box. Thus arranged, in the second or opened position, the floor box cover assembly enables an end-user to access a wiring device positioned within the floor box. In the first or closed position, the floor box cover assembly inhibits or covers the wiring device positioned within the floor box thereby preventing, or at least inhibiting, ingress of liquids (e.g., water), debris, dust, etc. Thus, in the first or closed position, the floor box cover assembly is arranged and configured to protect the wiring device, and any corresponding electrical connections associated therewith, from liquid (e.g., water), debris, dust, etc. In the second or opened position, the floor box cover assembly is arranged and configured to permit an end-user to access the wiring device positioned within the floor box while maintaining a low-profile to prevent, or at least inhibit, damage to the wiring device, floor box, floor box covering assembly, and/or injury to a person via, for example, tripping.

While the present disclosure will show the wiring device as an electrical receptacle or outlet, it should be appreciated that the wiring device may be any suitable wiring device now known or hereafter developed such as, for example, an electrical switch, a ground/arc fault circuit interrupter, a surge suppressor, a communication device, lighting controls, low voltage devices (e.g., ethernet ports, fiber optic ports, Universal Serial Bus ports), and the like. As such, it should be understood that the term “wiring device” is intended to include any now known or hereafter developed electrical device. As such, the present disclosure should not be limited to any particular wiring device unless explicitly claimed. In addition, the present disclosure should not be limited to any particular floor box unless explicitly claimed.

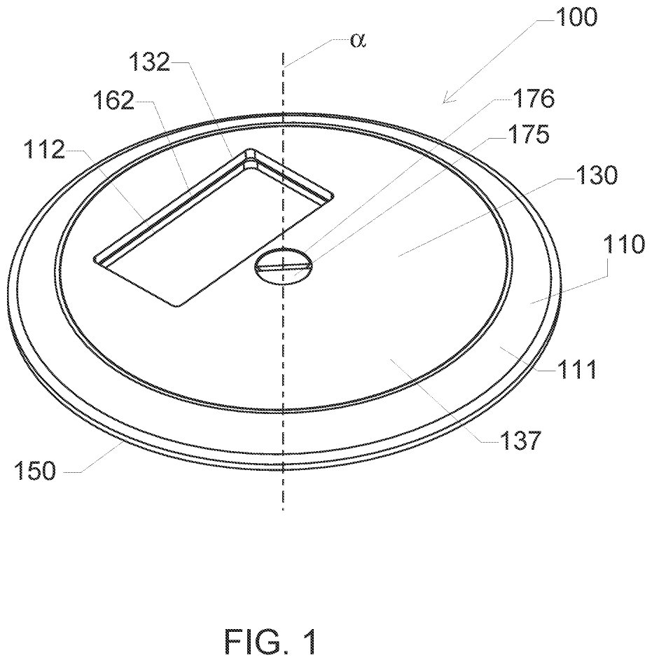

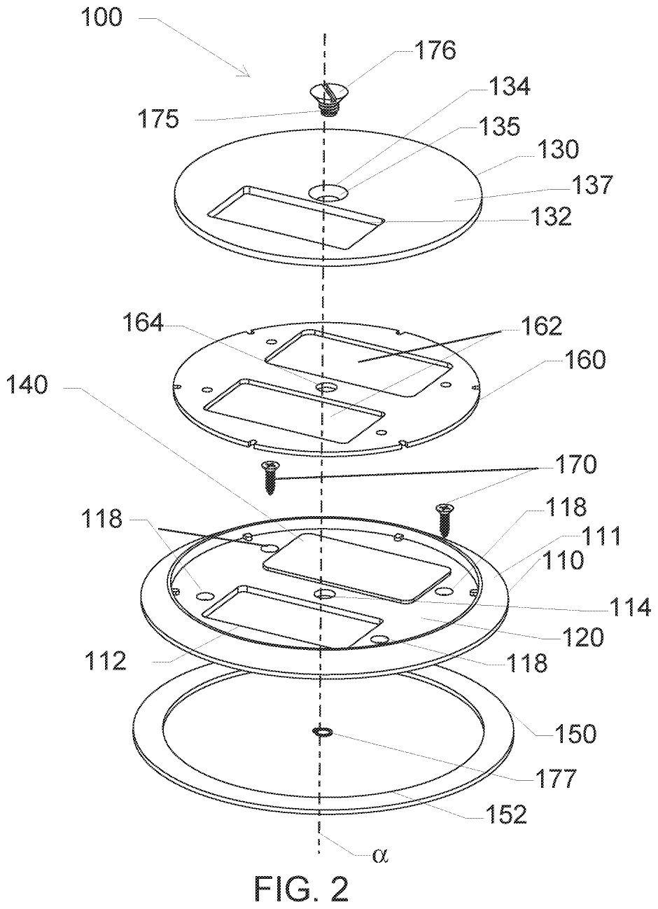

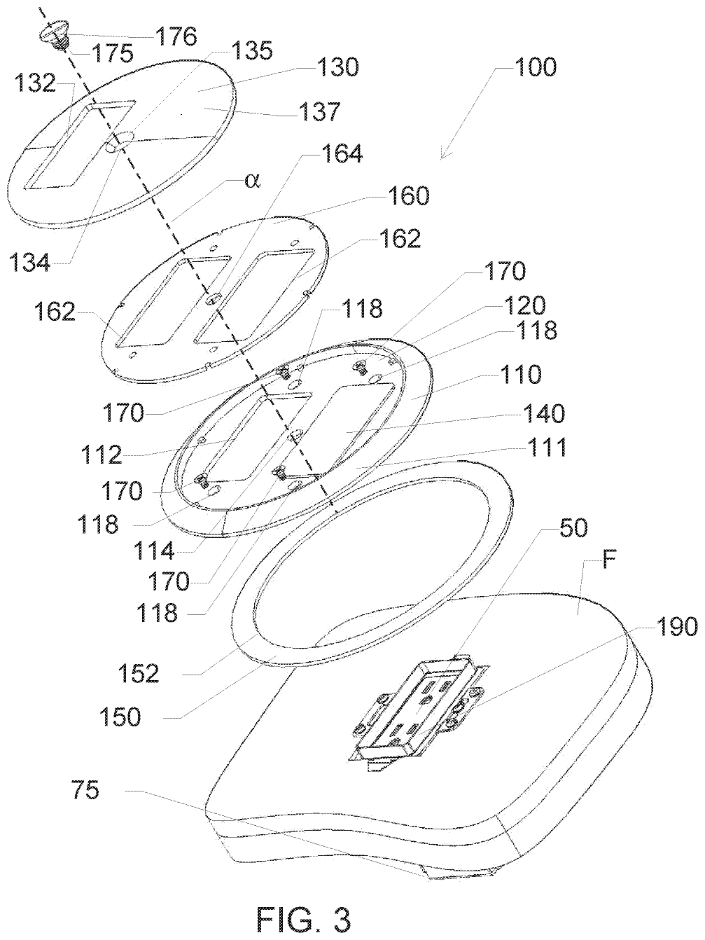

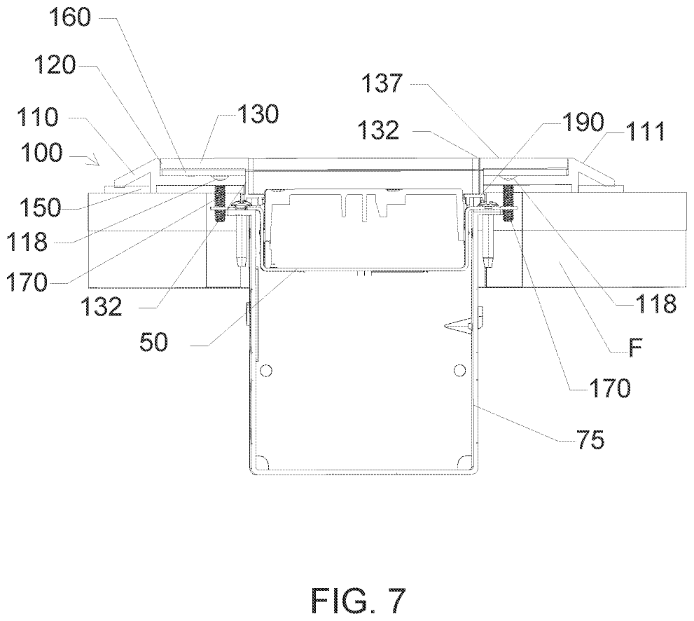

Referring to FIGS. 1-7, an embodiment of a floor box cover assembly 100 in accordance with one or more features of the present disclosure is shown. In one embodiment, as illustrated, the floor box cover assembly 100 includes a base plate 110 (also referred to as flange, terms base plate and flange used interchangeably herein without the intent to limit or distinguish) and a rotatable cover plate 130. In addition, the floor box cover assembly 100 may a first seal 150, a second seal 160, a plurality of fasteners 170, and a lock fastener 175.

As illustrated, in one embodiment, the floor box cover assembly 100, and hence the base plate 110, the rotatable cover plate 130, etc., may include a circular shape, although this is but one configuration and the floor box cover assembly 100, the base plate 110, the rotatable cover plate 130, etc. may have alternate shapes.

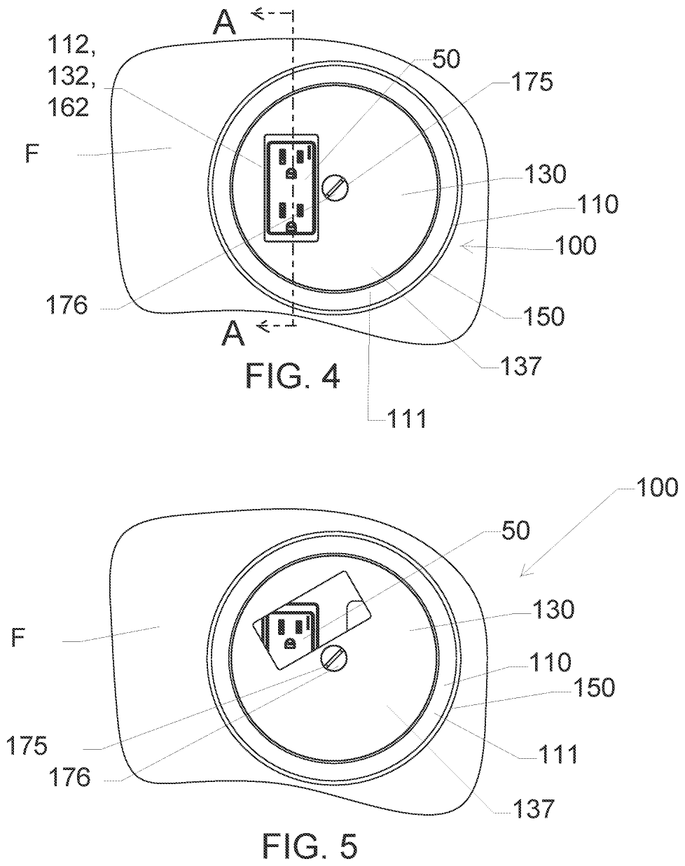

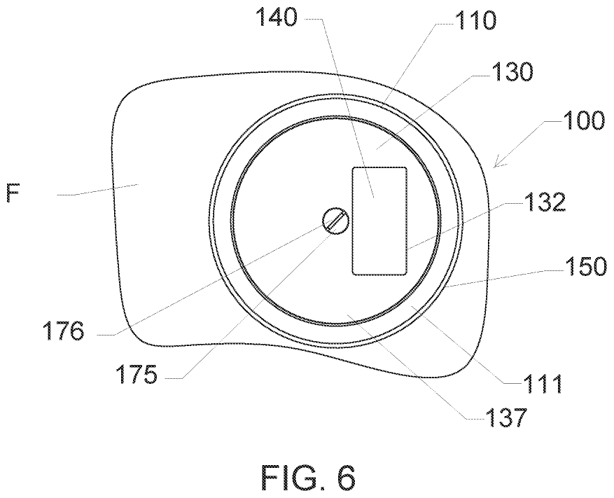

In accordance with one or more features of the present disclosure, as illustrated, in one embodiment, the base plate 110 includes an aperture 112 (corresponding to a single gang) to allow access to a wiring device 50 mounted within an electrical box 75 (e.g., a single-gang electrical box 75) positioned within the floor F. In addition, as illustrated, in one embodiment, the cover plate 130 includes an aperture 132. In one embodiment, the cover plate 130 is coupled to the base plate 110 such that the cover plate 130 can be rotated relative to the base plate 110 between the first/closed position and the second/opened position. Thus arranged, in use, as best illustrated in FIGS. 1 and 4, in the second or opened position, the aperture 132 formed in the cover plate 130 is aligned with the aperture 112 formed in the base plate 110 to allow access to the wiring device 50. Meanwhile, as best illustrated in FIG. 6, in the first or closed position, the aperture 132 formed in the cover plate 130 is not aligned with the aperture 112 in the base plate 110 thereby preventing access to the wiring device 50 from outside of the floor box cover assembly 100. FIG. 5 is a top view of the floor box cover assembly 100 illustrating the rotatable cover plate 130 transitioning (e.g., being rotated) between the first/closed position and the second/opened position.

In one embodiment, the aperture 112 formed in the base plate 110 may have a generally rectangular shape to accommodate the wiring device 50 such as, for example decorator type devices. However, other suitable shapes could be used such as oval, oblong, square, duplex receptacle (e.g., two separate openings per gang where each opening is in the shape of a circle with two equal circular segments removed) and the like. Similarly, the aperture 132 formed in the rotatable cover plate 130 may include a generally rectangular shape to accommodate the wiring device 50, although other similarly corresponding shapes are envisioned.

In use, the rotatable cover plate 130 may be coupled to the base plate 110 by any suitable mechanism now known or hereafter developed. As illustrated, in one embodiment, the cover plate 130 may include a hole 134 and the base plate 110 may include an internally threaded hole 114. Thus arranged, the lock fastener 175 may be positioned through the hole 134 formed in the cover plate 130, through a hole 164 formed in the second seal 160 (as will be described in greater detail below) and into engagement with the threaded hole 114 formed in the base plate 110. In use, an O-ring or similar seal may be included to seal against the aperture of the cover/base plate.

In use, with the lock fastener 175 loosened (e.g., not fully threaded), the cover plate 130 can be rotated relative to the base plate 110 between the first/closed position and the second/opened position. The cover plate 130 can rotate about axis alpha (a) when the lock fastener 175 is not fully tightened. Conversely, when the lock fastener 175 is fully tightened, the cover plate 130 is rendered fixed (e.g., non-rotatable) thereby securing the position of the cover plate 130 relative to the base plate 110. As illustrated, in one embodiment, the hole 134 formed in the cover plate 130 preferably includes a countersunk 135 and the lock fastener 175 may be a screw such as, for example, a flat head screw or a Phillips head screw. Thus arranged, when lock fastener 175 is fully tightened (e.g., fully threaded into the threaded hole 114 formed in the base plate 110), a top surface 176 of the lock fastener 175 is flush with a top surface 137 of the rotatable cover plate 130, thus minimizing a tripping hazard. In one embodiment, a lock clip 177 may be provided to engage the lock fastener 175 (e.g., a lower threaded portion of lock fastener 175). In use, the lock clip 177 prevents the lock fastener 175 from being disengaged from the floor box cover assembly 100, thus preventing the floor box cover assembly 100 from being unintentionally disassembled.

As previously mentioned, the cover plate 130 may be coupled to the base plate 110 by any suitable mechanism now known or hereafter developed. For example, an alternative embodiment may include a folding wing bolt instead of the lock fastener. A folding wing bolt may include a folding wing that lies flat when not in use, but which allows for an end-user to rotate the folding wing upwards to allow for the folding wing bolt to be tightened and loosened by the user without requiring the use of a screwdriver.

In one embodiment, as illustrated, the base plate 110 may be in the form of a circular plate including a beveled surface 111 around its perimeter. In use, the beveled surface 111 provides a transition between the floor F and the overall height of the floor box cover assembly 100, thus minimizing tripping hazards.

In one embodiment, the base plate 110 may include a raised surface, projection, etc. 140. As illustrated, in one embodiment, the raised surface 140 may include the same general shape as the aperture 132 formed in the rotatable cover plate 130. Thus arranged, in use, as best illustrated in FIG. 6, with the cover plate 130 rotated to the first or closed position, the raised surface 140 projects into the aperture 132 formed in the cover plate 130 to at least partially fill the otherwise empty space of the aperture 132. In this manner, the creation of a well or a recess in the floor box cover assembly 100 when in the first or closed position is prevented, or at least minimized, which prevents the collection of debris, water, etc. and facilitates the creation of a smooth, continuous top surface thereby preventing a tripping hazard when the cover plate 130 is in the first or closed position.

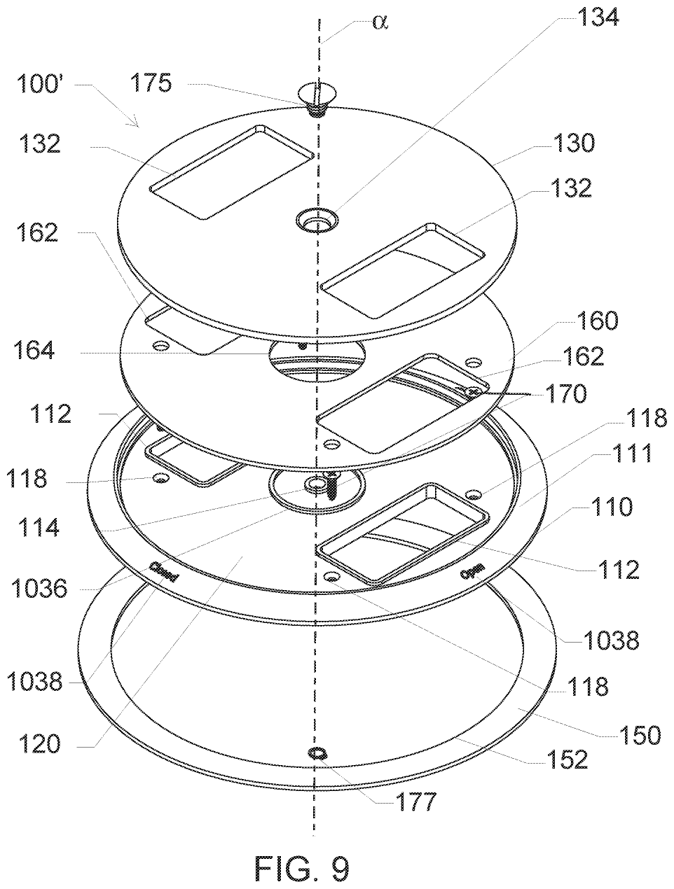

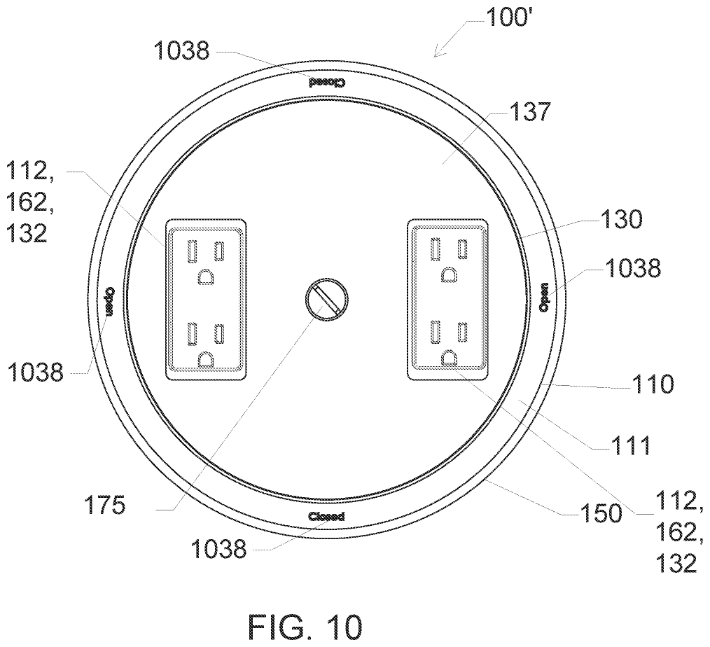

Alternatively, in an alternate embodiment, the base plate 110 may include a raised surface 140 that projects upward further (e.g., to a greater extent) and the rotatable cover plate 130 may be biased downward such that when the rotatable cover plate 130 is rotated to the first or closed position, the rotatable cover plate 130 may be biased downward over the raised surface 140 formed on the base plate 110 via, for example, a biasing member (e.g., a spring). In such an embodiment, when the rotatable cover plate 130 is rotated to the first or closed position, the raised surface 140 extends beyond the top surface 137 of the rotatable cover plate 130. In an alternative embodiment, the raised surface can be omitted entirely. In such an embodiment, the base plate could include a flat surface in the area or portion where the raised surface would otherwise be located. In this embodiment, there may only be a single aperture formed in the second seal (as will be described in greater detail below) to allow access to the wiring device 50. In a further alternative embodiment, with reference to FIGS. 9 and 10, a second aperture may be included in the portion or area where the raised surface would otherwise be located. In this further embodiment, the base plate 110 can optionally accommodate a second wiring device.

In use, in one embodiment, the base plate 110 may be coupled to the floor box by any suitable mechanism now known or hereafter developed. For example, as illustrated, in one embodiment, the base plate 110 may include a plurality of holes 118 arranged and configured to receive the plurality of fasteners 170 to secure the base plate 110 to the floor box 75.

As previously mentioned, the floor box cover assembly 100 may include a first seal 150 positioned between the base plate 110 and the floor F. Thus, in use, the first seal 150 prevents, or at least minimizes, the ingress of water, debris, etc. between the base plate 110 and the floor F. As illustrated, the first seal 150 may include an aperture 152 arranged and configured to receive the base plate 110 therein so that the first seal 150 surrounds the base plate 110.

In addition, as previously mentioned, the floor box cover assembly 100 may include a second seal 160. In use, the second seal 160 may be positioned between the base plate 110 and the rotatable cover plate 130 to prevent the ingress of water, debris, etc. between the base plate 110 and the rotatable cover plate 130. In one embodiment, as illustrated, the base plate 110 may include a cavity or recess 120. In use, the cavity or recess 120 is arranged and configured to receive the second seal 160 and the cover plate 130 therein so that, when assembled, the top surface 137 of the rotatable cover plate 130 sits flush with respect to the top surface of the base plate 110 (e.g., at the same height as the top of the beveled surface 111) thereby preventing, or at least minimizing, a tripping hazard. Alternatively, the top surface 137 of the rotatable cover plate 130 may sit below the top surface of the base plate 110 (e.g., the top surface 137 of the rotatable cover plate 130 may be slightly recessed).

In one embodiment, the second seal 160 may also include first and second apertures 162. In one embodiment, the apertures 162 formed in the second seal 160 may have a shape generally corresponding to the shape of the aperture 112 formed in the base plate 110, the shape of the raised surface 140 formed on the base plate 110, and the shape of the aperture 132 formed in the rotatable cover plate 130. As such, the apertures 162 formed in the second seal 160 may include a generally rectangular shape, although, once again, other suitable shapes could be used. In use, one of the apertures 162 formed in the second seal 160 is aligned with the aperture 112 formed in the base plate 110 to allow access to the wiring device 50. The other aperture 162 formed in the second seal 160 is aligned with the raised surface 140 formed on the base plate 110 so that the raised surface 140 at least partially fills and extends or protrudes through the aperture 162 formed in the second seal 160. The raised surface 140 may optionally provide a suitable surface for the end-user when the rotatable cover plate 130 is in the first or closed position and the raised surface 140 is exposed (e.g., by providing the raised surface 140 in the aperture 132 of the cover plate 130, a more aesthetic appearance is provided by filling in the space created by the aperture 132 when in the first or closed position). Additionally, the raised surface 140 optionally retains the relative position of the second seal 160 with respect to the base plate 110. As illustrated, and as previously mentioned, the second seal 160 may also include a hole 164 through which the lock fastener 175 extends.

In an alternative embodiment, the second seal 160 may only include a single aperture 162, while keeping the hole 164 (e.g., to accommodate a base plate 110 that does not include a raised surface 140). In a further alternative embodiment, the first seal 150 and/or second seal 160 may be omitted. In a further alternative embodiment, the base plate 110 may be sized and configured to be smaller than the rotatable cover plate 130. In this embodiment, the beveled surface 111 could be omitted from the base plate 110 and the rotatable cover plate 130 could instead include a beveled surface to fill the gap that would be otherwise exposed between the rotatable cover plate and the floor. In a still further alternative embodiment, the base plate 110 could be entirely omitted.

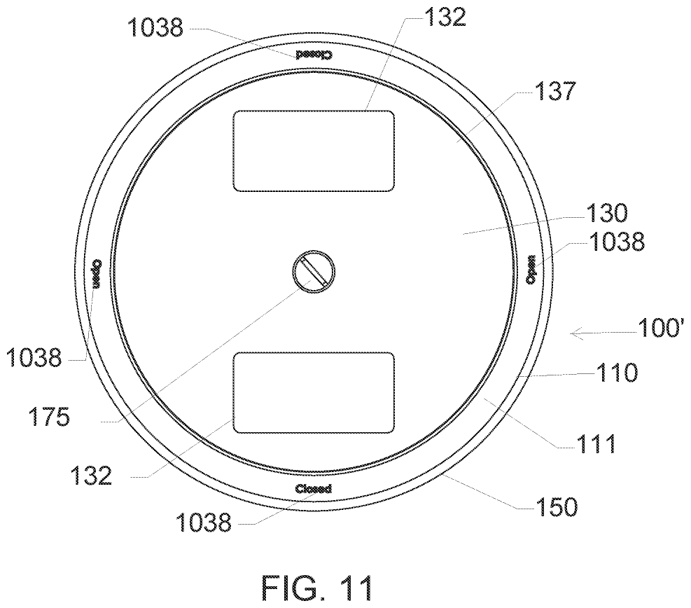

With reference to FIGS. 10 and 11, the base plate 110 may include suitable indicia 1038 such as “OPEN” and “CLOSED” to aid an end-user to indicate the respective open and closed positions of the rotatable cover plate 130. In addition, the indicia may include, for example, a marking such as, for example, an indicating arrow to coordinate with the indicia.

Thus arranged, in accordance with one or more features of the present disclosure, the floor box cover assembly 100 includes a rotatable cover plate 130 that is rotatable between a first or closed position (FIG. 6) and a second or opened position (FIG. 4). In the second or opened position, the aperture 132 formed in the rotatable cover plate 130 is aligned with the aperture 112 formed in the base plate 110 and the aperture 162 formed in the second seal 160 thus providing an end-user access to the wiring device 50 positioned within the floor box 75. In the first or closed position, the aperture 132 formed in the rotatable cover plate 130 is not aligned with the aperture 112 formed in the base plate 110 and the aperture 162 formed in the second seal 160 thereby preventing access to the wiring device 50 positioned within the floor box 75 In the first or closed position, the rotatable cover plate 130 may cover the wiring device 50 thereby preventing, or at least minimizing, the potential for debris, water, etc. to contact the wiring device 50. In addition, the raised surface 140 formed on the base plate 110 may extend into the aperture 132 formed in the rotatable cover plate 130 thereby creating a smooth, continuous top surface to prevent, or at least minimize, any tripping hazard and/or the potential for water or debris to collect within the aperture 132 formed in the rotatable cover plate 130.

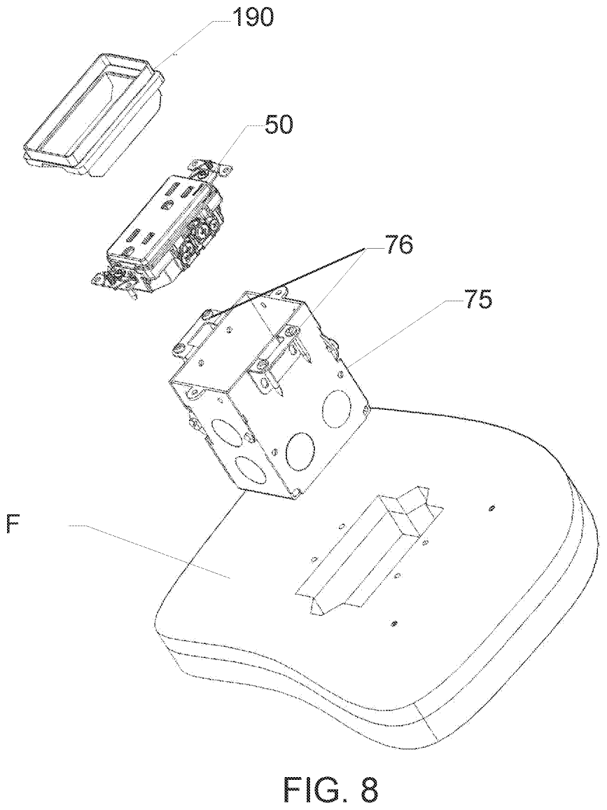

FIG. 8 is an exploded, perspective view illustrating a floor box 75 being installed within an opening formed in the floor F. The floor box 75 receiving a wiring device 50 and a mud ring 190. As illustrated, the floor box 75 may include brackets 76 to facilitate mounting of the electrical box 75 to the floor F. The mud ring 190 fills the gap between the edges of the electrical box 75 and the surface of the cavity 120 of the base plate 110. The mud ring 190 thus prevents access to live electrical parts that would otherwise be exposed by the gap between the electrical box 75 and the base plate 110.

Referring to FIGS. 9-11, an alternate embodiment of a floor box cover assembly 100′ is disclosed. Floor box cover assembly 100′ is substantially similar to floor box cover assembly 100 except as noted herein. In particular, floor box cover assembly 100′ is arranged and configured to accommodate two wiring devices (e.g., first and second wiring devices 50).

That is, in one embodiment, the raised surface of the base plate may be replaced with a second aperture 112 arranged and configured to receive a second wiring device, which may be positioned within the floor box 75. Similarly, the rotatable base plate and the optional second seal may each include a second aperture. Thus arranged, the base plate 110 includes first and second apertures 112, the rotatable cover plate 130 includes first and second apertures 132, and the second seal 160 includes first and second apertures 162. In use, the floor box cover assembly 100′ includes a rotatable cover plate 130 that is rotatable between a first or closed position (FIG. 11) and a second or opened position (FIG. 10). In the second or opened position, the apertures 132 formed in the rotatable cover plate 130 are aligned with the apertures 112 formed in the base plate 110 and the apertures 162 formed in the second seal 160 thus providing an end-user access to the wiring devices 50 positioned within the floor box 75. In the first or closed position, the apertures 132 formed in the rotatable cover plate 130 are not aligned with the apertures 112 formed in the base plate 110 and the apertures 162 formed in the second seal 160 thereby preventing access to the wiring device 50 positioned within the floor box 75 In the first or closed position, the rotatable cover plate 130 may cover the wiring devices 50 thereby preventing, or at least minimizing, the potential for debris, water, etc. to contact the wiring devices 50.

As illustrated, the floor box cover assembly 100′ may include a base plate 110 that further includes a ring 1036 which is arranged and configured to interact with the hole 164 formed in the second seal 160 to maintain the position of the second seal 160 relative to the base plate 110.

FIG. 10 is a top view of the floor box cover assembly 100′ being shown where the rotatable cover plate 130 is in the second or opened position. In the second or opened position, corresponding groups of apertures 132 formed in the rotatable cover plate 130 are aligned with the group of apertures 112, 162 formed in the base plate 110 and the second seal 160, thus providing access to the wiring devices from outside of the floor box cover assembly 100′.

FIG. 11 is a top view of the floor box cover assembly 100′, where the rotatable cover plate 130 is in the first or closed position. In the first or closed position, the apertures 132 formed in the rotatable cover plate 130 are not aligned with the corresponding apertures 112, 162 formed in the base plate 110 and the second seal 160, thus preventing access to the wiring devices from outside of the floor box cover assembly 100′.

As illustrated in FIGS. 10 and 11, in one embodiment, the floor box cover plate assembly 100′ may include indicia 1038 indicating for example, “OPEN” and “CLOSED”. In one embodiment, the indicia 1038 may be located on the beveled surface 111 of the base plate 110 as an aid to an end-user to indicate the respective open and closed positions of the rotatable cover plate 130. Optionally, the cover plate 130 or bevel may also include raised or recessed arrows, dots or some other indicator.

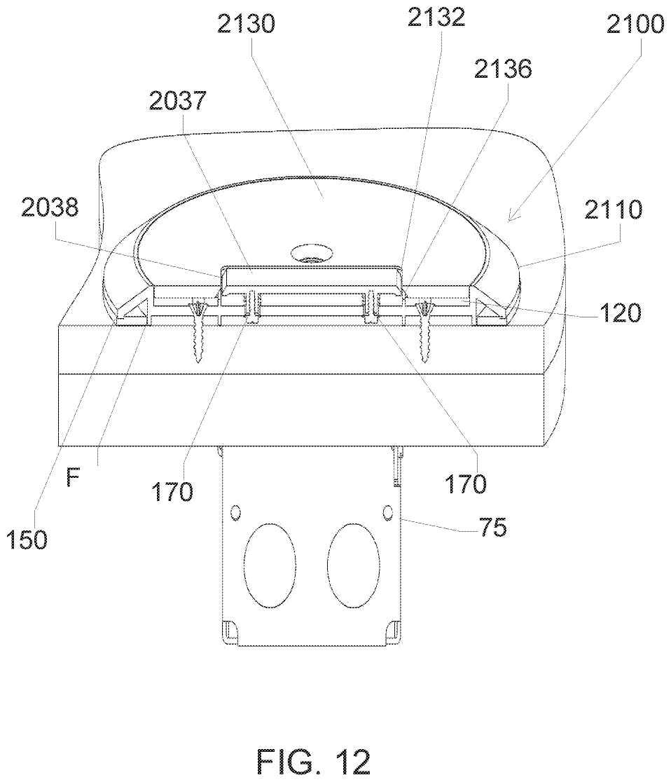

With reference to FIG. 12, a cross-sectional, perspective view of an alternate embodiment of a floor box cover assembly 2100 in accordance with one or more features of the present disclosure is shown. In use, the floor box cover assembly 2100 is substantially similar to floor box cover assembly 100 except as noted herein. In particular, in accordance with the present embodiment, the floor box cover assembly 2100 eliminates the raised surface formed on the base plate and replaces the raised surface with a filler plate 2037 such as, for example, a spring-loaded filler plate. As illustrated, in one embodiment, the spring-loaded filler plate 2037 may have a size and shape substantially similar to the size and shape of the wiring device (e.g., a size and shape substantially similar to the size and shape of the aperture formed in the rotatable cover plate).

In use, and as previously described in connection with the previously described floor box cover assemblies, the floor box cover assembly 2100 includes a rotatable cover plate 2130 include an aperture 2132. As previously described, in the second or opened position, the aperture 2132 formed in the rotatable cover plate 2130 is aligned with the wiring device and the aperture formed in the base plate to allow access to the wiring device. Once the rotatable cover plate 2130 is rotated to the first or closed position, the spring-loaded filler plate 2037 is aligned with and pops-up into the aperture 2132 formed in the rotatable cover plate 2130. Thus, with the rotatable cover plate 2130 in the first or closed position, the spring-loaded filler plate 2037 may optionally prevent rotation of the rotatable cover plate 2130 out of the first or closed position (e.g., if ramp 2136 on aperture 2132 and ramp 2038 on the spring-loaded filler plate 2037 are omitted). As such, the spring-loaded filler plate 2037 may make tightening of the lock fastener (e.g., lock fastener 175) unnecessary to fix the position of the rotatable cover plate 2130 with respect to the base plate 2110. However, in the embodiment shown, the aperture 2132 formed in the rotatable cover plate 2130 includes a ramp 2136 and the spring-loaded filler plate 2037 includes a ramp 2038. Due to the inclusion of the ramps 2136 and 2038, when an end-user attempts to rotate the rotatable cover plate 2130 out of the first or closed position, the interaction between the ramps 2136 and 2038 cooperate to push the spring-loaded filler plate 2037 downward, allowing the rotatable cover plate 2130 to rotate, for example, from the first or closed position to the second or opened position.

In an alternate embodiment, the floor box cover assembly 2100 may include first and second apertures 2132 where the first aperture 2132 allows for access to a wiring device and the second aperture 2132 receives the spring-loaded filler plate 2037 once the rotatable cover plate 2130 is rotated into the second or opened position.

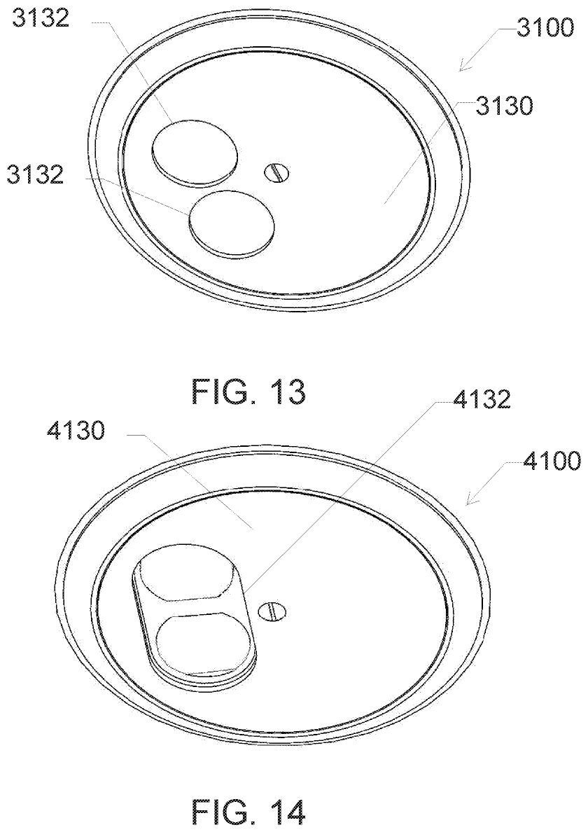

As previously mentioned, the apertures formed in the base plate, the second seal, and the rotatable cover plate may have any size and shape, which as will be appreciated by one of ordinary skill in the art, is partially dependent on the type and form of wiring device being utilized. For example, with reference to FIG. 13, the floor box cover assembly 3100 may include apertures 3132 formed in the rotatable cover plate 3130 that allow for access to a duplex wiring device in the second or opened position. In this embodiment, as illustrated, the apertures 3132 may have a circular shape, although the apertures 3132 can be of any suitable shape as discussed above. For example, with reference to FIG. 14, the floor box cover assembly 4100 may include an oval aperture 4132 formed in the rotatable cover plate 4130 that allow for access to a duplex wiring device in the second or opened position.

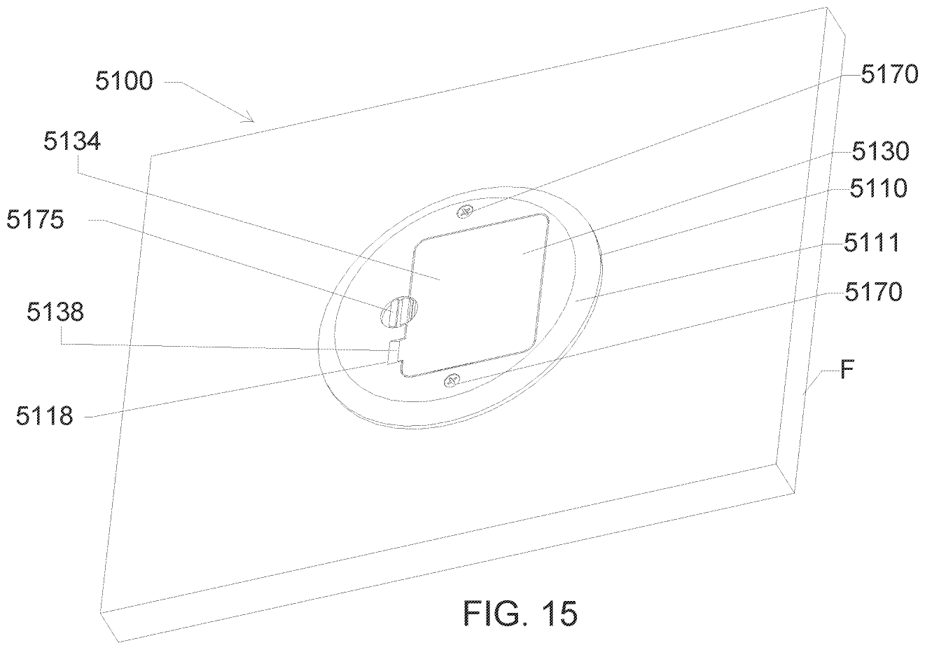

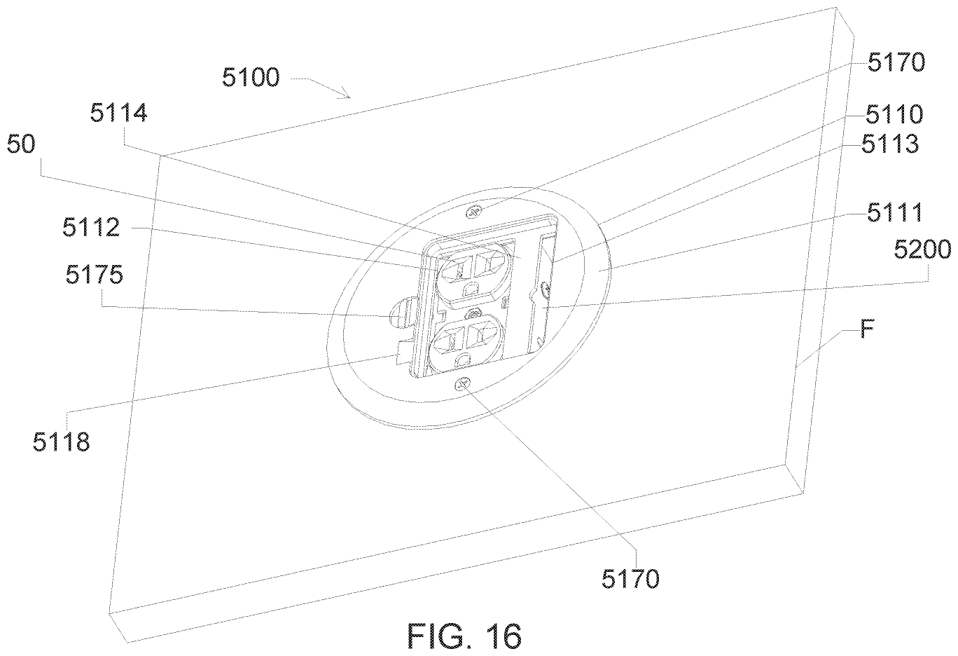

With reference to FIGS. 15-19, an alternate embodiment of a floor box cover assembly 5100 in accordance with one or more features of the present disclosure is shown. As illustrated, and as will be described in greater detail herein, in one embodiment, the floor box cover assembly 5100 includes a base plate 5110, a plurality of fasteners 5170, a cover plate 5130, a cover storage box 5200 and a plate fastener 5175.

In use, the cover plate 5130 is arranged and configured to move between a first or closed position and a second or opened position. In the second or opened position, access to the wiring device 50 is provided while in the first or closed position, the cover plate 5130 covers, seals, etc. the wiring device 50 thereby preventing access to the wiring device 50. In the second or opened position, the cover plate 5130 is arranged and configured to be stored or stowed-away within a recess or cavity formed in the cover storage box 5200. Thus arranged, the floor box cover assembly 5100 maintains a low-profile in the second or opened position thereby eliminating, or at least minimizing, a tripping hazard.

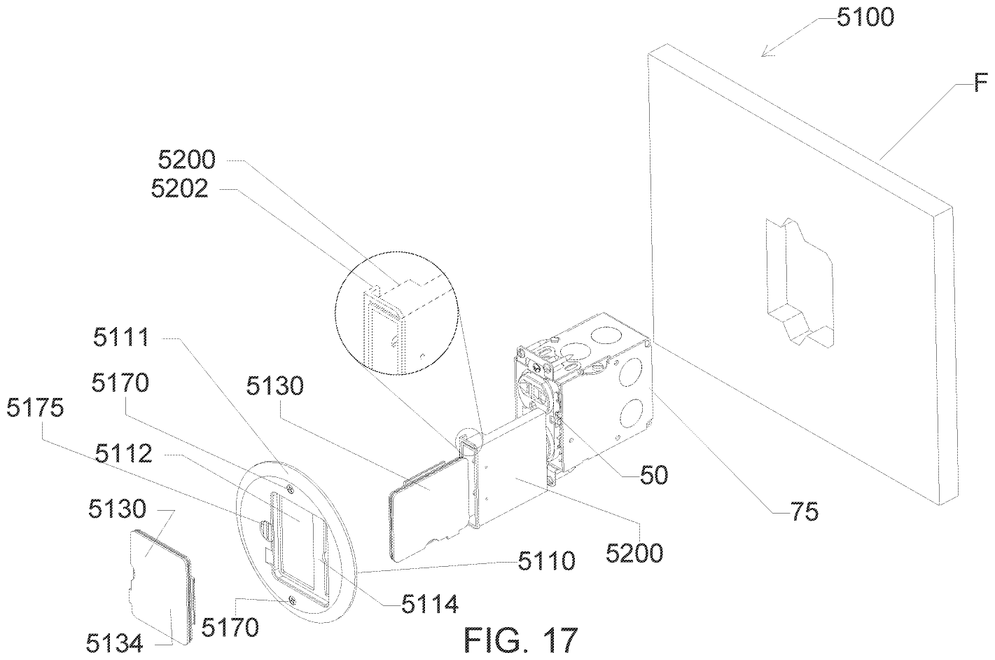

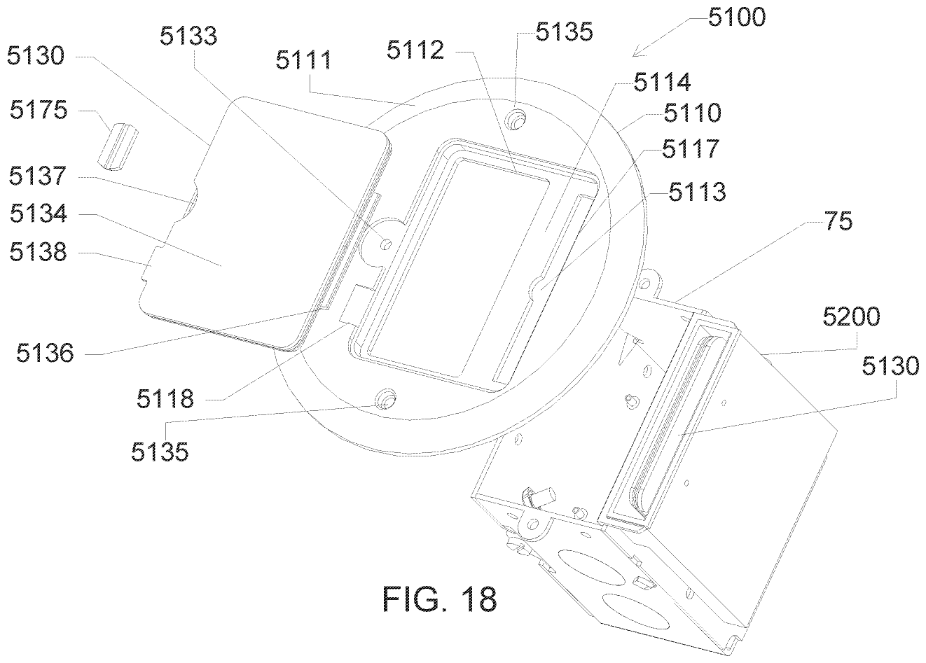

In use, as will be appreciated by one of ordinary skill in the art, the floor box cover assembly 5100 is arranged and configured to be installed within a floor F. For example, as best represented in FIG. 17, the electrical junction box 75 may be positioned within an opening formed in a floor F. Thereafter, a wiring device 50 may be installed within the electrical junction box 75. Subsequently, the base plate 5110 may be coupled to the electrical junction box 75 via fasteners 5170. That is, as illustrated, in one embodiment, fasteners 5170 project through apertures 5135 (FIG. 18) formed in the base plate 5110 and secure the base plate 5110 to the electrical junction box 75. A first seal may be optionally included to prevent the ingress of liquids (e.g., water) and debris between the base plate 5110 and the floor F.

In one embodiment, as illustrated, the base plate 5110 may be provided in the form of a circular plate and may include a beveled surface 5111 around its perimeter, although this is but one configuration and the base plate 5110, and hence the floor box cover assembly 5100, may be provided in other suitable shapes. The beveled surface 5111 providing a transition between the floor F and the overall height of the floor box cover assembly 5100 thereby minimizing a tripping hazard.

In addition, the base plate 5110 includes a wiring device aperture 5112 (corresponding to a single gang) to allow access to the wiring device 50 mounted in the electrical junction box 75 (e.g., a single-gang electrical box 75) in the floor F. The wiring device aperture 5112 is generally rectangular shaped to accommodate decorator type devices, although the aperture may have other shapes. As illustrated, in one embodiment, and as will be described in greater detail below, the base plate 5110 also includes a second aperture 5113 arranged and configured to provide access to the cover storage box 5200.

As previously mentioned in connection with other embodiments, the base plate 5110 may also include a cavity 5114 arranged and configured to receive the cover plate 5130 and the plate fastener 5175 such that, in use, with the cover plate 5130 in the first or closed position, a top surface 5134 of the cover plate 5130 sits flush, or slightly below or recessed, with respect to the top of the base plate 5110 thereby minimizing the extent to which the floor box cover assembly extends from floor F to minimize any tripping hazard. A portion of the cavity 5114 is positioned adjacent to the wiring device aperture 5112. In addition, the base plate 5110 also includes a plate fastener aperture 5133 (FIG. 18) through which the plate fastener 5175 is received.

Optionally, a second seal may be positioned between the base plate 5110 and the cover plate 5130. The second seal, if present, prevents the ingress of liquids (e.g., water) and debris between the base plate 5110 and the cover plate 5130.

In use, the cover plate 5130 may be coupled to the base plate 5110 by any suitable mechanism now known or hereafter developed. For example, in one embodiment, as illustrated, the cover plate 5130 may include a tongue 5136 (FIG. 18) arranged and configured to contact, engage, etc. the base plate 5110. For example, in one embodiment, the cover plate 5130 may be installed by positioning the tongue 5136 underneath an edge 5117 of the cavity 5114, and releasing the cover plate 5130 so it sits in the cavity 5114 formed in the base plate 5110.

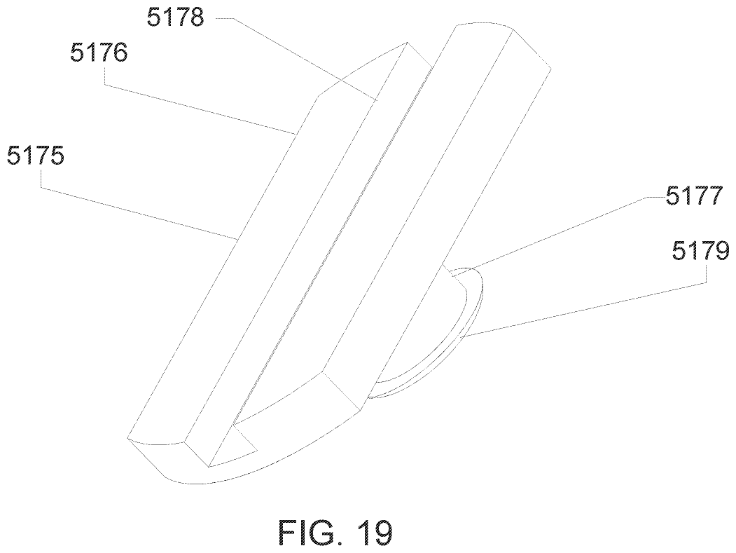

In addition, the cover plate 5130 may be coupled or locked to the base plate 5110 by any suitable mechanism now known or hereafter developed. For example, in one embodiment, as illustrated, the floor box cover assembly 5100 may include a plate fastener 5175 for securing or locking the cover plate 5130 to the base plate 5110 in the first or closed position. As best illustrated in FIG. 19, in one embodiment, the plate fastener 5175 includes a head portion 5176 and a shank portion 5177. As illustrated, the head portion 5176 may include a slot 5178 arranged and configured to receive, for example, a screwdriver. That is, in use, the slot 5178 allows an end-user to utilize a screwdriver to rotate the plate fastener 5175. The shank portion 5177 may include an enlarged end portion 5179 arranged and configured to prevent complete removal of the plate fastener 5175 from the base plate 5110. That is, during assembly, the shank portion 5177 of the plate fastener 5175 is inserted into the plate fastener aperture 5133 (FIG. 18). Thereafter, the enlarged end portion 5179 of the shank portion 5177 may be swaged or deformed, etc. within the plate fastener aperture 5133 to prevent removal of the plate fastener 5175 from the plate fastener aperture 5133. For example, a die or a similar tool may be used to swage or deform the enlarged end portion 5179 of the plate fastener 5175. As such, the swaging operation prevents the plate fastener 5175 from being disengaged from the floor box cover assembly 5100. Alternative embodiments include deforming, or rolling, the enlarged end portion 5179 of the plate fastener 5175 instead of a swaging operation.

As best illustrated in FIG. 18, the cover plate 5130 may also include a recess 5137 and a tab 5138. In use, with the cover plate 5130 in the first or closed position, the top surface of the head 5176 of the plate fastener 5175 is flush with the top surface 5134 of the cover plate 5130, thus minimizing a tripping hazard. In the first or closed position, the plate fastener 5175 may be positioned such that the slot 5178 is substantially perpendicular to the edge 5117. As such, a portion of the head 5176 is received within the recess 5137 of the cover plate 5130 to secure the cover plate 5130 in place. Thereafter, to remove the cover plate 5130 and to transition the floor box cover assembly 5100 to the second or opened position, the plate fastener 5175 can be rotated such that the slot 5178 is substantially parallel to the edge 5117 so that the portion of the head 5176 is no longer within the recess 5137 of the cover plate 5130. A user can then lift tab 5138 to remove the cover plate 5130 (the tab 5138 having been received within a recess 5118 of the base plate 5110 when the cover plate 5130 is installed). If the user wishes to store the cover plate 5130, the cover plate 5130 may be positioned or stored in the cover storage box 5200. In one embodiment, the end-user may insert the cover plate 5130 through the second aperture 5113 of the base plate 5110 and into cover storage box 5200. In one embodiment, the cover plate 5130 may be oriented with its short sides parallel to the floor F.

As illustrated, in one embodiment, the cover storage box 5200 may be a separate and independent component from the electrical junction box 75. Alternatively, the electrical junction box 75 and the cover storage box 5200 may be integrally or monolithically formed. If separately and independently formed, the cover storage box 5200 may be coupled to the electrical junction box 75 by any suitable mechanism now known or hereafter developed including, for example, screws or fasteners. For example, as illustrated, in one embodiment, the cover storage box 5200 may include a projection 5202 such as, for example, an “L” shaped projection, extending from the cover storage box 5200. In one embodiment, the projection 5202 may extend from a long side of the coverage storage box 5200. When the cover storage box 5200 is assembled onto the electrical box 75, the “L” shaped projection 5202 engages one of the long walls of the electrical box 75. The cover storage box 5200 may then be fastened to the electrical box via screws or the like.

In use, the cover storage box 5200 may be of any suitable shape and size. The cover storage box 5200 may have one or more recesses, stepped portions, cavities, or pockets to provide clearance to avoid elements outside the cover storage box 5200. In the embodiment shown, the cover storage box 5200 steps down to a narrower width at a point roughly a third of its depth below the surface of the floor F. In this particular embodiment, this was done to avoid interference with fasteners on the electrical box 75.

In use, as previously mentioned, when the end-user desires to access the wiring device 50 positioned within the electrical junction box 75, the cover plate 5130 may be removed from the base plate 5110 by rotating or unlocking the plate fastener 5175. Thereafter, the cover plate 5130 can be positioned or stored inside of the cover storage box 5200. Note, FIGS. 17 and 18 illustrate two cover plates 5130 representing the position of the cover plates 5130 in the first or closed position and the second or opened position (e.g., positioned within the cover storage box 5200). In use, only one cover plate 5130 may be present.

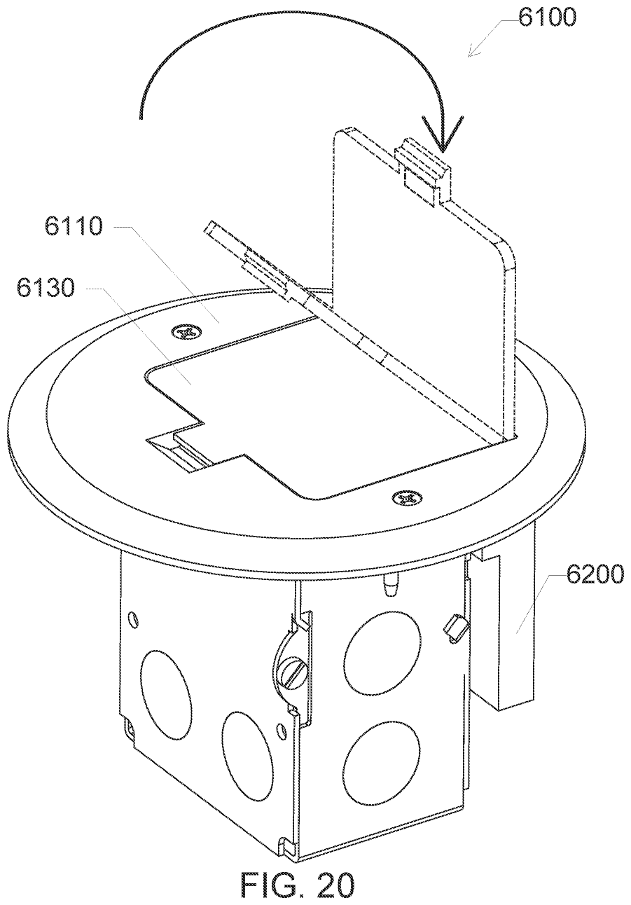

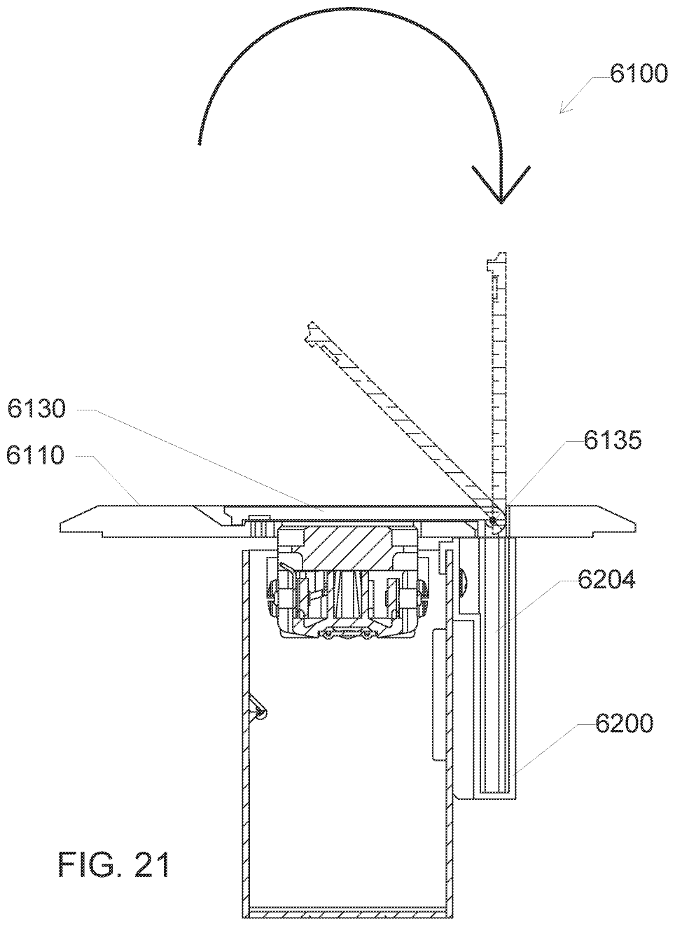

Referring to FIGS. 20 and 21, an alternate embodiment of a floor box cover assembly 6100 is disclosed. In use, the floor box cover assembly 6100 is substantially similar to floor box cover assembly 5100 except that the cover plate 6130 is held captive to the base plate 6110. That is, the cover plate 6130 is no longer detachable or removable from the base plate 6110. Rather, in use, the cover plate 6130 can be rotated from a first position to a second position, and then positioned within the cover storage box 6200. For example, in one embodiment, the cover plate 6130 may include two hinge pins 6135 projecting from the cover plate 6130. In use, the hinge pins 6135 project into respective tracks or rails 6204 formed in the cover storage box 6200. In order to transition from the first/closed position to the second/opened position, the cover plate 6130 is rotated in the direction of the arrow until the cover plate 6130 is in the vertical position. Thereafter, the cover plate 6130 can be slid down into the cover storage box 6200. In one embodiment, the tracks 6204 may be closed at both ends so the cover plate 6130 cannot be unintentionally removed from the floor box cover assembly 6100. In alternative embodiments, the tracks 6204 may be opened at one or both ends so the cover plate 6130 can be removed from the floor box cover assembly 6100.

In FIGS. 20 and 21, the cover plate 6130 is shown in the first or closed position with solid lines and in the transitioning and second or opened positions with dashed lines.

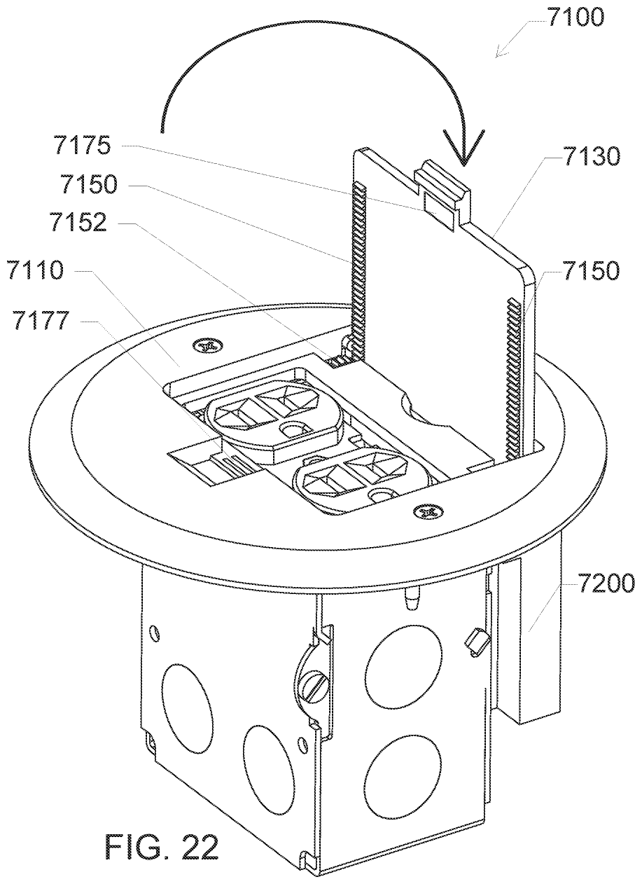

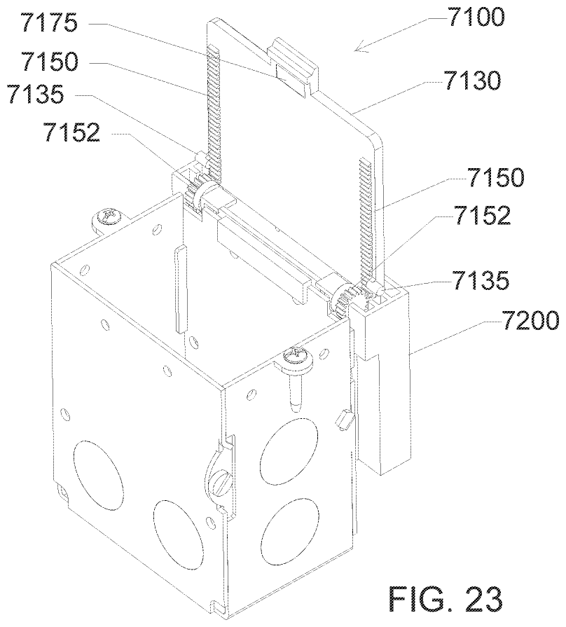

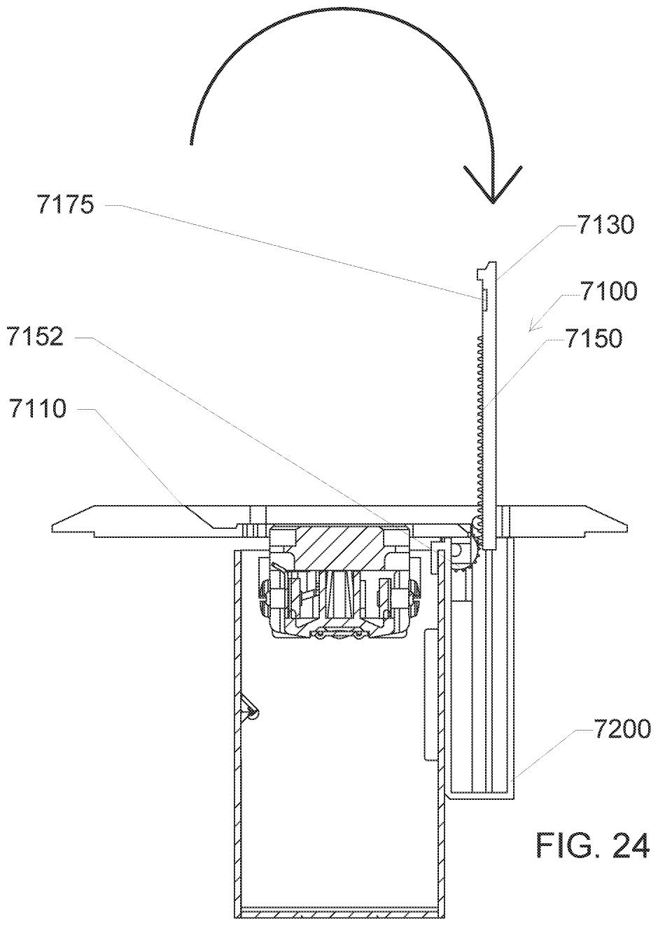

Referring to FIGS. 22-24, another embodiment of a floor box cover assembly 7100 is disclosed. The floor box cover assembly 7100 is substantially similar to floor box cover assemblies 5100, 6100 except that the cover plate 7130 is held captive to the base plate 7110. For example, as illustrated, the cover plate 7130 may be held captive to the base plate 7110 via two sets of racks 7150 and pinions 7152. As illustrated, in one embodiment, the racks 7150 may be located on the cover plate 7130 and the pinions 7152 may be located on the cover storage box 7200, or vice-versa.

In use, each rack 7150 engages or interacts with each pinion 7152, respectively in order to allow the cover plate 7130 to retract downward into the cover storage box 7200 or to extend upward and out of the cover storage box 7200. When the cover plate 7130 extends upward and out of the cover storage box 7200, the cover plate 7130 can rotate about an axis that the hinge pins 7135 are located on (the hinge pins 7135 may each engage tracks similar to tracks 6204 previously described). Optionally, when rotating about hinge pins 7135, the racks 7150 may disengage from the pinions 7152. The racks 7150 may include an optional stop at one of both ends to prevent the racks 7150 from being unintentionally disengaged from the pinions 7152. Optionally, rotation of the cover plate from a closed position to an open position may be assisted by means of springs, torsion springs, etc. to automatically tilt the cover plate once released from the magnet latch described below.

In one embodiment, the cover plate 7130 may include a ferrous plate 7175 and the base plate 7110 may include magnets 7177. In one embodiment, the magnets 7177 may be provided in the form of two elongated strips. In use, the ferrous plate 7175 and magnets 7177 cooperate to retain the cover plate 7130 in the first or closed position (e.g., the top surface of the cover plate 7130 being flush with the top surface of the base plate 7110). As such, the ferrous plate 7175 and the magnets 7177 may be used in place of a plate fastener as previously described. In other embodiments, the relative placements of the ferrous plate 7175 and magnets 7177 may be swapped or changed to any suitable location. In still other embodiments, any suitable number of ferrous plates and magnets may be used, and these elements can take any suitable shape or orientation.

In use, the floor box cover assembly including the cover plate and the base plate may be manufactured from any suitable material now known or hereafter developed. For example, in one embodiment, the cover plate and the base plate may be manufactured from brass. Alternatively, one or both of the cover plate and the base plate may be manufactured from a ferrous material, or any other suitable, material. If one of the cover plate or the base plate is manufactured from a ferrous material, then the ferrous plate can be omitted from such embodiments.

While the present disclosure makes reference to certain embodiments, numerous modifications, alterations, and changes to the described embodiments are possible without departing from the sphere and scope of the present disclosure, as defined in the appended claim(s). Accordingly, it is intended that the present disclosure not be limited to the described embodiments, but that it has the full scope defined by the language of the following claims, and equivalents thereof. The discussion of any embodiment is meant only to be explanatory and is not intended to suggest that the scope of the disclosure, including the claims, is limited to these embodiments. In other words, while illustrative embodiments of the disclosure have been described in detail herein, it is to be understood that the inventive concepts may be otherwise variously embodied and employed, and that the appended claims are intended to be construed to include such variations, except as limited by the prior art.

The foregoing discussion has been presented for purposes of illustration and description and is not intended to limit the disclosure to the form or forms disclosed herein. For example, various features of the disclosure are grouped together in one or more embodiments for the purpose of streamlining the disclosure. However, it should be understood that various features of the certain embodiments of the disclosure may be combined in alternate embodiments. Moreover, the following claims are hereby incorporated into this Detailed Description by this reference, with each claim standing on its own as a separate embodiment of the present disclosure.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

The phrases “at least one”, “one or more”, and “and/or”, as used herein, are open-ended expressions that are both conjunctive and disjunctive in operation. The terms “a” (or “an”), “one or more” and “at least one” can be used interchangeably herein. All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the present disclosure, and do not create limitations, particularly as to the position, orientation, or use of this disclosure. Connection references (e.g., engaged, attached, coupled, connected, and joined) are to be construed broadly and may include intermediate members between a collection of elements and relative to movement between elements unless otherwise indicated. As such, connection references do not necessarily infer that two elements are directly connected and in fixed relation to each other. All rotational references describe relative movement between the various elements. Identification references (e.g., primary, secondary, first, second, third, fourth, etc.) are not intended to connote importance or priority, but are used to distinguish one feature from another. The drawings are for purposes of illustration only and the dimensions, positions, order and relative to sizes reflected in the drawings attached hereto may vary.

What is claimed is:

1. A floor box cover assembly arranged and configured to be coupled to a floor box, which houses a wiring device, the floor box cover assembly comprising:
a base plate including an aperture to allow access to the wiring device positioned within the floor box; and
a cover plate rotatably coupled to the base plate, the cover plate including an aperture, the cover plate being rotatable between a first position and a second position to enable selective access to the wiring device positioned within the floor box;
wherein, in the first position, the aperture formed in the cover plate is not aligned with the aperture formed in the base plate to prohibit access to the wiring device; and
wherein, in the second position, the aperture formed in the cover plate is aligned with the aperture formed in the base plate to enable an end-user to access the wiring device positioned within the floor box.

2. The floor box cover assembly of claim 1, further comprising a lock fastener arranged and configured to couple the cover plate to the base plate, wherein, in a loosen state, the lock fastener allows the cover plate to rotate relative to the base plate between the first and second positions, and in a tightened state, the cover plate is non-rotatable relative to the base plate.

3. The floor box cover assembly of claim 1, wherein the base plate further comprises a raised surface including a size and shape corresponding to the aperture formed in the cover plate, wherein in the first position, the raised surface of the base plate projects into the aperture formed in the cover plate.

4. The floor box cover assembly of claim 3, further comprising a seal positioned between the base plate and the cover plate, the seal arranged and configured to prevent ingress of water and debris between the base plate and the cover plate.

5. The floor box cover assembly of claim 4, wherein the base plate includes a cavity arranged and configured to receive the seal and the cover plate therein so that, when assembled, a top surface of the cover plate sits flush with respect to a top surface of the base plate.

6. The floor box assembly of claim 4, wherein the seal includes first and second apertures, each of the first and second apertures including a size and shape corresponding to a size and shape of the apertures formed in the base plate and cover plate, the first aperture formed in the seal is aligned with the aperture formed in the base plate to allow access to the wiring device, the second aperture formed in the seal is aligned with the raised surface formed on the base plate so that the raised surface protrudes through the second aperture of the seal.

7. The floor box cover assembly of claim 1, wherein the base plate includes indicia arranged and configured to indicate a position of the cover plate.

8. A floor box cover assembly arranged and configured to be coupled to a floor box, which houses a wiring device, the floor box cover assembly comprising:
a cover plate including an aperture sized and configured to enable access to the wiring device positioned within the floor box;
a base plate including an aperture to allow access to the wiring device positioned within the floor box and a raised surface including a size and shape corresponding to the aperture formed in the cover plate;
wherein the cover plate is rotatably coupled to the base plate, the cover plate being rotatable between a first position and a second position;
wherein, in the first position, the aperture formed in the cover plate is not aligned with the aperture formed in the base plate to prohibit access to the wiring device, the aperture formed in the cover plate is aligned with the raised surface of the base plate so that the raised surface protrudes into the aperture formed in the cover plate; and
wherein, in the second position, the aperture formed in the cover plate is aligned with the aperture formed in the base plate to enable an end-user to access the wiring device positioned within the floor box.

9. The floor box cover assembly of claim 8, further comprising a lock fastener arranged and configured to couple the cover plate to the base plate, wherein, in a loosen state, the lock fastener allows the cover plate to rotate relative to the base plate between the first and second positions, and in a tightened state, the cover plate is non-rotatable relative to the base plate.

10. The floor box cover assembly of claim 8, further comprising a seal positioned between the base plate and the cover plate, the seal arranged and configured to prevent ingress of water and debris between the base plate and the cover plate.

11. The floor box cover assembly of claim 10, wherein the base plate includes a cavity arranged and configured to receive the seal and the cover plate therein so that, when assembled, a top surface of the cover plate sits flush with respect to a top surface of the base plate.

12. The floor box assembly of claim 10, wherein the seal includes first and second apertures, the first aperture formed in the seal is aligned with the aperture formed in the base plate to allow access to the wiring device, the second aperture formed in the seal is aligned with the raised surface formed on the base plate so that the raised surface protrudes through the second aperture of the seal.

13. A floor box cover assembly arranged and configured to be coupled to a floor box, which houses a wiring device, the floor box cover assembly comprising:
a base plate arranged and configured to couple to the floor box, the base plate including an aperture to enable access to the wiring device;
a cover plate coupled to the base plate, the cover plate moveable between a first position and a second position to enable selective access to the wiring device; and
a cover storage box arranged and configured to receive the cover plate;
wherein, in the first position, the cover plate is coupled to the base plate and extends across the aperture to prohibit access to the wiring device; and
wherein, in the second position, the cover plate is positioned within the cover storage box to enable an end-user to access the wiring device positioned within the floor box.

14. The floor box cover assembly of claim 13, further comprising a plate fastener arranged and configured to secure the cover plate to the base plate in the first position.

15. The floor box cover assembly of claim 13, wherein the cover plate is detachably coupled to the base plate so that, in the second position, the cover plate is detached from the base plate and stored in the cover storage box.

16. The floor box cover assembly of claim 13, wherein the base plate includes a second aperture arranged and configured to provide access to the cover storage box.

17. The floor box cover assembly of claim 13, wherein the cover plate is hingeably coupled to the base plate.

18. The floor box cover assembly of claim 13, wherein the cover plate and the base plate further comprise a rack and pinion to move the cover plate relative to the base plate.

19. The floor box cover assembly of claim 18, further comprising a spring arranged and configured to facilitate moving the cover plate relative to the base plate.
